(19) United States
(12) Patent Application Publication
(10) Pub. No.: US 2019/0292023 A1
(43) Pub. Date: Sep. 26, 2019

(54) TRANSPORTABLE INLINE HEAVE COMPENSATOR

(71) Applicant: SAFELINK AS, Skien (NO)

(72) Inventor: Tord B MARTINSEN, Skien (NO)

(73) Assignee: SAFELINK AS, Skien (NO)

(21) Appl. No.: 16/304,518

(22) PCT Filed: May 26, 2017
(86) PCT No.: PCT/NO2017/050135

§ 371 Date: Nov. 26, 2018

(30) Foreign Application Priority Data
May 27, 2016 (NO) 20160909
Dec. 15, 2016 (NO) 20161987
Dec. 30, 2016 (NO) 20162072

(51) Int. Cl. B66C 13/10; B63B 27/10; F16H 19/04; F15B 1/24; F15B 1/027; F15B 11/16; F15B 15/28; F15B 15/14

(52) U.S. Cl. CPC B66C 13/105; F15B 2211/71; F16H 19/04; F15B 1/24; F15B 1/027; F15B 11/16; F15B 15/28; F15B 15/14; F15B 2201/31; F15B 2211/212; F15B 2211/205; F15B 2211/255; F15B 2211/41572; F15B 2211/7051; B63B 27/10

(57) ABSTRACT

Transportable inline heave compensator provided with connection devices for suspending the compensator from a load bearing device and a connection device for a carrying a payload, where the compensator comprises a passive heave compensator part and possibly an active heave compensator part, and being provided with a sensor arrangement, where the compensator further comprises at least one actuator, that is horizontally oriented in operation and comprises an actuator piston rod with a horizontally stroke indirectly connected to a rope means, where the rope means at an end, via a connection device, such as a padeye, is connected to at least one of; a vessel at the sea surface or a payload, incorporating a device with a curved surface where rope means is suspended to for converting the vertical movements of vessel or payload to horizontal movements of the actuator piston rod compensating the load.

The transportable inline heave compensator is an installation tool designed to compensate vertical heave motion during sensitive installations/lifts of payloads in an offshore environment. The vertical heave source is typically induced by swells that cause floating objects, like installation vessels and barges, but not limited thereto, to move vertically up and down. The transportable inline heave compensator is designed to operate in air and in water. The transportable inline heave compensator is an inline tool that combines the principles of spring isolation and may be used with an active cylinder control in order to generate an efficient compensation effect

### BACKGROUND OF THE INVENTION

The tool can operate like a traditional gas-over-hydraulic fluid spring-dampening device if the active control malfunctions. During offshore construction, high and heavy structures are to be lowered by expensive working ships with big cranes of high carrying capacity. The structures have to be lifted from fixed or floating objects and be placed on either fixed or floating locations, topside or subsea. Irregular movements of working ships, barges and supply vessels generated by swell and wind can be increased a lot by the crane boom, so that even with average swell it is difficult or impossible to carry by the crane sensitive structures during violent ship and crane movements and to lower them subsea. Since daily costs of operation with working ships are very high, each delay causes enormous additional costs. Therefore, a strong demand exists to perform respective works also in less favourable weather and with average swell without damaging the structures to be moved. The prior art compensation devices, such as crane mounted active heave compensators, have a very high capital cost and have several weaknesses, where the biggest ones are, no mobility, insufficient splash zone crossing performance, fatigue of wire rope, lack of passive backup systems, high power demand and lack of models for heavy lifts.

Many prior art passive (PHC) and active (AHC) heave compensators exist, like e.g. US 20080251980, US 20150362039, US 20080105433. The main difference between the invention and traditional PHC units is that the invention uses a drum fitted with one or more rope means as the length extension means, while a traditional PHC uses a hydraulic actuator as the length extension means. Compared to AHC, one of the differences between the prior art and the invention is for example that the transportable inline heave compensator is a transportable compensator for inline use with a passive backup system to go subsea with the payload being installed. Traditional active compensators often do not have a passive backup system and always stay topside on a vessel.

U.S. Pat. No. 3,743,249 A describes an apparatus for maintaining a constant tension in a cable. The apparatus comprises a cylinder/piston assembly, a drum, spirally shaped to keep the tension in the cable independent of the position of the piston, and a rack and a pinion as a means for converting longitudinal displacements of the piston into rotation of the cable drum.

GB 2187159 A, describes a lifting apparatus with sheave blocks and compensators connected to one of the sheave blocks to prevent transmission of motions, as wave motions, from the block to carried load. A fluid actuated booster piston-cylinder assembly is interconnected with the compensator to permit greater loads to be carried for the same range of movement of the compensator.

US 2015/129529 A1 describes a marine lifting apparatus with active heave compensation including a main chassis, a drive assembly with a lifting column comprising a gear rack, a pinion, and a motor. A control circuitry is commanding the drive assembly to cause the lifting column to translate on the heave motion detected by a sensor.

Compared to AHC, one of the differences between the prior art and the invention is for example that the transportable inline heave compensator is a mobile compensator for inline use with a passive backup system to go subsea with the payload being installed. Traditional active compensators often do not have a passive backup system and always stay topside on a vessel.

The main disadvantages of the prior art are: high capital binding in permanently installed (i.e. not mobile) equipment which is often only needed a few weeks per year, high installation costs, high maintenance costs (especially related to fatigue in crane steel wire rope), poor splash zone crossing performance due to fast dynamics, poor performance for short wave periods due to fast dynamics, poor resonance protection, high power demand and lack of existing models for heavy lifts.

### SUMMARY OF THE INVENTION

The main features of the present invention are given in the independent claim. Additional features of the invention are given in the dependent claims.

The transportable inline heave compensator is basically a passive heave compensator which traditionally is an inline tool, with an optional added active component to increase the performance. The transportable inline heave compensator consists of one or more actuators connected to one or more gas accumulators, which might be double acting accumulators, which is further connected to one or more gas tanks.

The transportable inline heave compensator is naturally depth compensated and allows for efficient usage of available pumps for active actuator control. Influences like temperature variations and load variations are handled by the active compensation system.

Active control of the actuator is used to compensate for heave motion. The active control is controlled by sensors, where the most important ones are the piston position or drum angle sensor, the accelerometer and the wire rope speed sensor, i.e. via a computer, which able compensator to increase or reduce gas pressure in tanks and accumulators individually by use of i.e. control valves, gas boosters, pressure intensifiers etc. Information about the wire rope speed is transferred to the compensator via wireless signals while the compensator is in air and via acoustic transmission while it is submerged.

The transportable inline heave compensator can operate in several different modes with variable stiffness and damping with or without active control of the actuator and with or without active control of the pressure levels in the various gas volumes. The transportable inline heave compensator is energy efficient due to the fact that passive part of the compensator carries the entire load of the payload weight and the actively controlled hydraulic motors(s) only have to compensate for gas compression effects and friction, which typically is maximum 15% of the force compared to static force, and usually much less. Energy regeneration is also used so that only friction as well as oil leakage and mechanical losses in the hydraulic pump contributes to the energy consumption. When active control of the actuator is not required the transportable inline heave compensator may use the active system to charge the internal battery pack. Further, acoustic communication subsea and wireless communication topside allow for control and monitoring of the compensator, on-board sensors allow the user to verify performance after a lift is concluded.

The invention has the following advantages compared to the prior art; MOBILE construction, lower cost for same capacity, as good performance for long wave periods and better performance for short wave periods, excellent splash zone crossing performance, well-suited for resonance protection, reduced wear of the steel wire rope, low energy consumption, reduced lifting height requirement, no upending required.

The main features of this patent application, which are new compared to previous applications:
Horizontal design
Increased stroke versus required lifting height
No need for upending of the compensator (from horizontal to vertical)
Simpler passive depth compensation
New accumulator design, more efficient and cheaper construction

The new actuator design allows for horizontal construction of the compensator, which gives two large benefits. One, the elongation of the compensator can be long without increasing the effective vertical length of the compensator. Two, troublesome upending of the compensator from horizontal position on the vessel deck to vertical position (hanging in the crane hook) is removed as it is ready to go when lifted straight up from the vessel deck. It also worth noting that a very simple, effective and cheap passive depth compensation can be used with this actuator design. The improved gas accumulator design allows for simpler construction at a lower cost compared to prior art.

### BRIEF DESCRIPTION OF THE DRAWINGS

FIG. 1 shows how the drum with rope means, the rack and pinion and the actuator pistons are connected. Most other details are left out.

FIG. 2 shows a more detailed version of the transportable inline heave compensator, with a two drum design, accumulators and tanks are not shown.

FIG. 3 shows a top view of a two drum transportable inline heave compensator, without accumulators and tanks.

FIG. 4 shows a schematic of a passive transportable inline heave compensator.

FIG. 5 shows a schematic of an active transportable inline heave compensator.

FIG. 6 shows a transportable inline heave compensator drum with variable diameter.

FIG. 7 shows the actuator of a compression-based design with horizontally mounted sheaves on the actuator rod, viewed from a horizontal plane. Gas tanks and accumulators are not shown.

FIG. 8 shows the actuator of a tension-based design with horizontally mounted sheaves on the actuator rod, viewed from a horizontal plane. Gas tanks and accumulators are not shown.

FIG. 9 shows the actuator of a compression-based design with horizontally mounted sheaves on the actuator rod, viewed from a vertical plane. Gas tanks and accumulators are not shown.

FIG. 10 shows a simplified hydraulic circuit for a compression-based system.

FIG. 11 shows a simplified hydraulic circuit for a tension-based system.

FIG. 12 shows the actuator of a compression based design with horizontally mounted sheaves on the cylinders, viewed from a horizontal plane. The advantage compared to vertical mounting is reduced lifting height requirement and no upending is required. Compression based designs also allows for more compact designs (possible to utilize more of the actuator cylinder). Gas tanks and accumulators are not shown. Note that the sheave arrangement might be modified slightly to make the two wire ropes collinear.

FIG. 13 shows the actuator of a compression based design with horizontally mounted sheaves on the cylinders, viewed from a vertical plane. Gas tanks and accumulators are not shown. Note that the sheave position is for illustration purposes only and may be placed higher or lower, it is also feasible to have a sheave block at the payload connection if desired.

FIG. 14 shows the actuator of a tension based design with vertically mounted sheaves on the cylinders, viewed from a horizontal plane. Tension based designs can use smaller piston rods, which cost less; due to no buckling effect. Also depth compensation is cheaper on this type of design for the same reason. The downside is the larger horizontal space requirement. Gas tanks and accumulators are not shown. Note that the sheave arrangement might be modified slightly to make the two wire ropes collinear.

FIG. 15 shows the actuator of a tension based design with vertically mounted multi fall sheaves on the cylinders; viewed from a horizontal plane. Multi fall designs can increase the elongation length without increasing horizontal length. Gas tanks and accumulators are not shown. Note that the sheave arrangement might be modified slightly to make the two wire ropes collinear.

FIG. 16 shows the actuator of a tension based design with vertically mounted sheaves on the cylinders, viewed from a vertical plane. Support legs are shown as well as lifting points. Note that the sheave position is for illustration purposes only and may be placed higher or lower, it is also feasible to have a sheave block at the payload connection if desired.

FIG. 17 shows a depth compensated actuator. The depth compensation is performed by the tail rod, which has the same diameter as the piston rod.

FIG. 18 shows a simplified hydraulic circuit for a compression based system. Note that the actuator is simplified to one cylinder.

FIG. 19 shows a simplified hydraulic circuit for a tension based system. Note that the actuator is simplified to one cylinder.

FIG. 20 shows a placement of the transportable inline heave compensator in a topside lift, wherein it is located right above a payload located on a barge.

FIG. 21 shows a placement of the transportable inline heave compensator in a subsea lift, wherein it is located right above a payload, which is symbolized with a rectangle.

FIG. 22 is an illustration of a prior art active heave compensator, permanently installed topside.

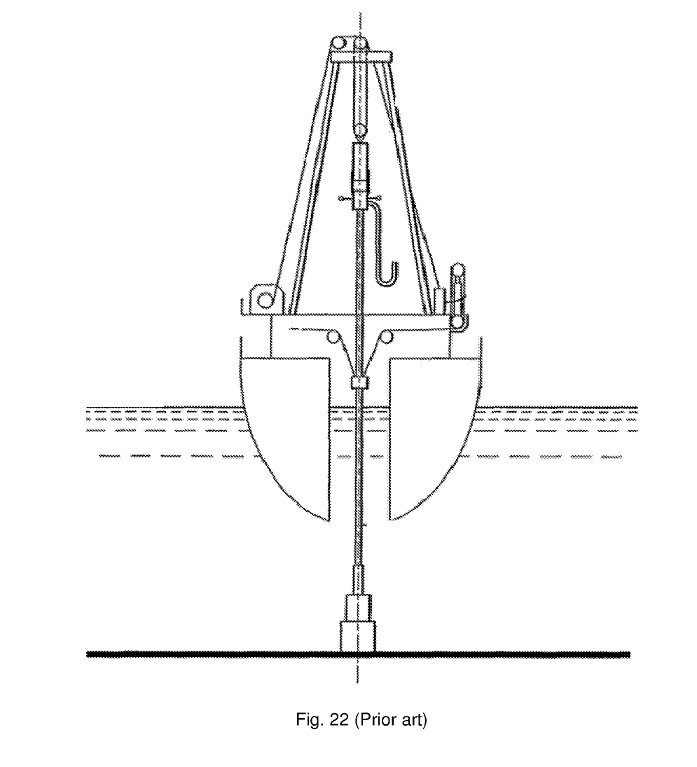

### DETAILED DESCRIPTION OF THE EMBODIMENTS

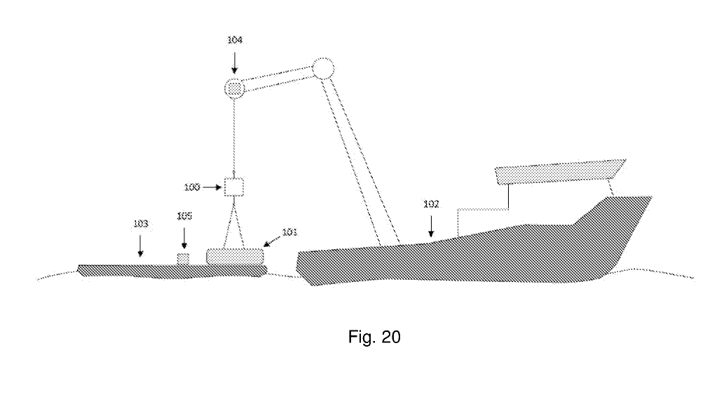

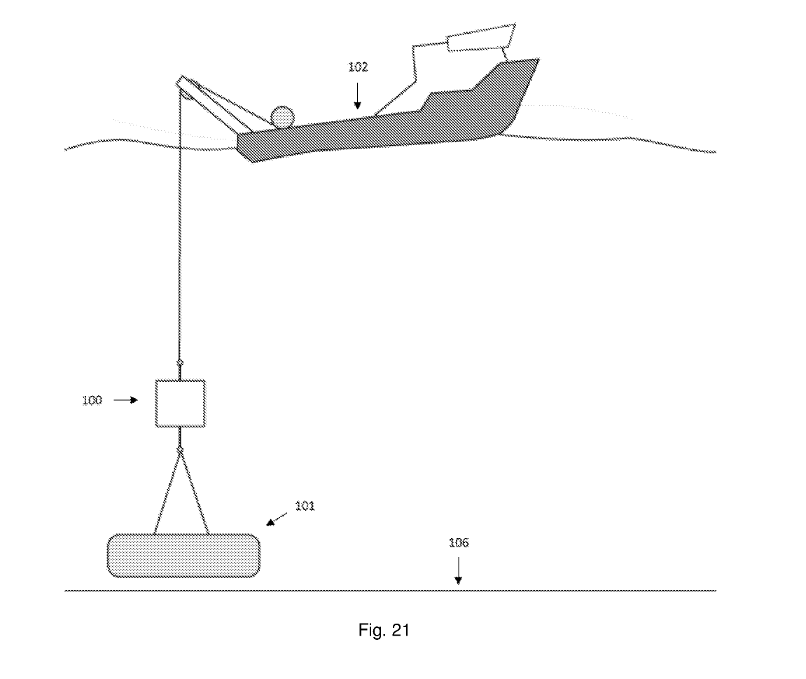

The following section will describe how a transportable inline heave compensator (100) according to the present invention works during different phases of an offshore subsea lift. One possible application is shown, where it is assumed that a payload (101) is initially on a barge (103) next to an installation vessel (102), as shown in FIG. 20. The payload (101) has to be retrieved by the vessel (102). Then the payload (101) needs to cross the splash zone. Next there is a descent of the payload (101) into deeper waters, and finally landing of the payload (101) on the seabed (106), as shown in FIG. 21. Here the payload (101) should be at rest relative to the seabed (106).

There are different requirements to functionality during the different phases of the lifting operation. During the first phase, which is lifting of the payload (101), that is located on a floating barge (103), from a floating vessel (101), it is beneficial if the transportable inline heave compensator (100) can compensate motion in such a way that the relative motion between the lower part of the transportable inline heave compensator (100) and the barge (103) deck is zero, except for winch spooling. This functionality requires three things:
1. Velocity of the barge (103) deck
2. Velocity of the crane hook
3. Winch speed (i.e., wire rope spooling velocity)

The first requirement is handled by a wireless MRU (105), short for motion reference unit, placed on the barge (103) deck, preferably close to the payload (101). The second requirement is either handled by an accelerometer inside the transportable inline heave compensator (100), or by a MRU (104) located on the vessel (102) or in the crane. The final requirement is normally given by the crane computer, and is transferred wirelessly while in air, or via acoustic signals when submerged, to the transportable inline heave compensator (100).

Based on the information above the computer integrated into the transportable inline heave compensator (100) is able to control the actuator (10) in such a way that the relative motion between the lower part of the transportable inline heave compensator (100) and the barge (103) deck is close to zero while the crane winch is not spooling out wire rope. The computer will take spooling into account, to not cause any lag for the crane operator.

After successful connection and lifting of the payload (101) from the barge (103) deck, the payload (101) has to cross the splash zone (i.e., the border between air and sea), where different requirements apply. This phase is characterized by fast dynamics, where unpredictable forces from slamming and buoyancy occurs and is best suited for a passive heave compensator, which the transportable inline heave compensator (100) basically is. Active actuator (10) control is turned off, stiffness and damping is adjusted to the best possible settings by use of control valves (CV). During the actual crossing of the splash zone, the actuator (10) equilibrium position tends to move towards the inner position, due to buoyancy forces acting on the payload (101). This effect is compensated by adjusting the internal gas pressure in one of the following ways:
1. Release gas to the surroundings
2. Transfer gas from the gas accumulator (30, 70) to a tank with lower pressure
3. Transfer gas from the gas accumulator (30, 70) to a tank with higher pressure by utilizing the gas booster (160)

The adjustment is performed automatically by the on-board computer based on changing equilibrium position of the actuator (10).

At a certain distance after crossing the splash zone, the transportable inline heave compensator (100) will often switch to a softer setting with less damping. This is done to prevent resonance in the lifting arrangement. If the passive system alone is not enough to avoid resonance, then the actuator (10) can either be locked by closing control valves or actively controlled by the computer to prevent resonance.

Drop in temperature during transport from shallow waters to deeper waters influence the equilibrium position of the actuator (10). The water temperature often tends to decrease as the transportable inline heave compensator (100) is lowered into deeper waters. This affects the actuator (10) equilibrium due to the fact that the gas pressure in all gas volumes are reduced due to lowered temperature. The transportable inline heave compensator (100) compensates this either by transferring gas under higher pressure from one of the tanks to the gas accumulator (30) via control valves or from a tank under lower pressure to the gas accumulator (30) via the gas booster (160) or pressure intensifier (141) and control valves (CV). The second and often most important effect is the increasing water pressure.

During the final phase of the lifting operation, which is the landing phase, the active actuator (10) control is again enabled, either by acoustic commands, water pressure triggering or by an ROV, to ensure that there is minimal relative velocity between the lower end of the transportable inline heave compensator (100) and the seabed (106). The on-board computer uses the on-board accelerometer, the position sensor (90) or drum angle sensor (91) as well as acoustically transmitted signals from the vessel (102) about wire rope spooling to actively control the actuator (10) to a high degree of accuracy and without crane operator lag. The water pressure sensor (indirectly measures distance) can also be used in improving the control signal.

The energy source for the compensator can be either a battery pack or an energy source on the vessel connected to the compensator via an umbilical.

The sketches or figures shown are intended to show the principles of the invention, wherein numerous variations with a number of accumulators and tanks can be utilized in order to get the same results

According to one embodiment of the invention a transportable inline heave compensator comprises minimum one drum, minimum one first actuator, consisting of a cylinder and a piston located inside the cylinder and adapted for reciprocation with respect thereto, minimum one rack and pinion, linking together the drum and the first actuator piston, and converts the rotational motion of the drum and pinion to linear motion of the rack and first actuator piston. The embodiment further comprises bearing means for the drum to allow rotation of the drum, structure means/framework linking the bearing means to the first actuator, which are immovable relative to each other, minimum one first accumulator, fluidly connecting the first actuator at either the rod side or the piston side, minimum one rope means connected to the drum in one end and a connection device in the other end and minimum one second connection device attached to either of; a rope means or a fixed point on the compensator.

An accelerometer (92) can measure the position of the transportable inline heave compensator (100), which position is affected by the movement of the vessel (102), Drum angle sensor(s) (91) can measure the movement of the payload (101). If the payload (101) is not at rest, the means for hydraulic fluid transportation (180) will either push or brake the piston (42) in the second actuator (40), so that the net movement of the payload (101) will be zero. Communication means (145) transfers signals from the vessel about crane winch spooling to the transportable inline heave compensator (100), so that such effects can be quickly incorporated into the actions of the means for hydraulic fluid transportation (180).

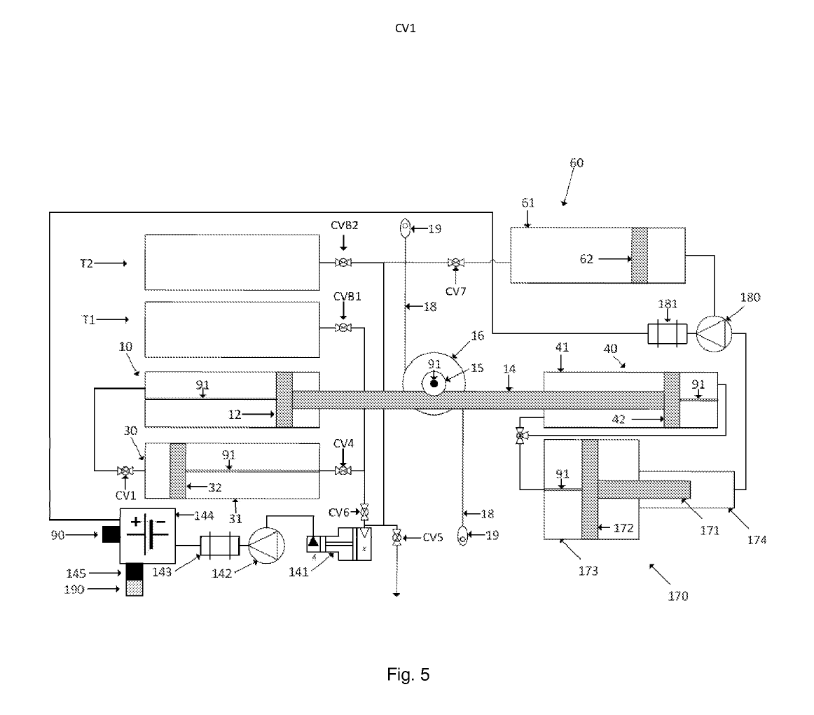

The transportable inline heave compensator (100) can comprise a sensing arrangement or means, such as for example at least one drum angle sensor (91), shown with alternative placements in FIG. 5, e.g. On the drum (16), in the first actuator (10), in the second actuator (40), in the first accumulator (30) or in the pressure intensifier (170). Based on direct or indirect measurements from at least one of these sensors (91), along with measurements from an accelerometer (92) and/or a water pressure sensor (93) and/or communication means (145), the transportable inline heave compensator (100) will be able to calculate how a means for hydraulic fluid transportation (180) should operate to transport hydraulic fluid between a hydraulic fluid volume in the pressure intensifier (170) and another hydraulic fluid volume in the second accumulator (60) in order to continuously have a net zero relative motion between at least one of the connection device (19) and the seabed (106).

When the payload (101) at the barge (103) is connected to the transportable inline heave compensator (100), the torque acting on the drum (16) is increased to almost carry the load (about 90% of static weight) of the payload (101). When desired by the crane operator, a fast pressure increase can be performed to quickly lift (i.e. Faster than normal crane speed) the payload (101) from the barge (103) in order to reduce risk of contact between the barge (103) deck and the payload (101) after lift-off, the pressure increase is performed by injecting gas from a second tank (T2) or by using the means for hydraulic fluid transportation (180). The barge (103) is then relocated, and the payload (101) is ready to cross the splash zone. During the splash zone crossing phase, the transportable inline heave compensator (100) is operating in a passive mode, with no active control of the drum (16), except for equilibrium adjustments (wanted equilibrium angle (or “stroke”) is pre-set) due to environmental disturbances, such as increased buoyancy and/or changing temperature. After crossing the splash zone, the stiffness of the transportable inline heave compensator (100) is reduced by connecting a first tank (T1). This is crucial to provide good resonance protection. During the lowering phase, the pump (180) can be used to charge an energy source (144), adapted for supplying the transportable inline heave compensator (100) with power, by utilizing the hydraulic fluid flow in the transportable inline heave compensator (100). The equilibrium angle (or “stroke”) of the drum (16) is maintained by a means for gas transportation (140) that adjusts the pressure of the different gas volumes in the transportable inline heave compensator (100). The landing phase mode is either activated based upon water depth or activated by a ROV (the ROV turns a switch on the transportable inline heave compensator (100)). During this phase, the heave motion of the payload (101) will be close to zero, and it can safely be installed. The heave motion is partly compensated by the passive spring (i.e. A gas volume in the first accumulator (30), and a gas volume in the first tank (T1)), and partly by the means for hydraulic fluid transportation (180), transferring fluid in and out of the second actuator (40) via the pressure intensifier (170).

Transportable inline heave compensator (100) is provided with connection devices (19) for suspending the compensator (100) from a load bearing device and a connection device (19) for a carrying a payload (101), The compensator (100) is comprising a passive heave compensator part and possibly an active heave compensator part, and is provided with a sensor arrangement, where the compensator (100) further comprises at least one actuator (10) that is horizontally oriented in operation and comprises an actuator piston rod (13) with a horizontally stroke indirectly connected to a rope means (18), with indirectly it is understood that it is not directly connected to the piston rod but connected via an element that is connected at the end of the piston rod, either at a sheave or to a drum that is in connection with the piston rod via a rack and a pinion, where the rope means (18) at an end, via a connection device (19), such as a padeye, is connected to at least one of; a vessel (102) at the sea surface or a payload (101), incorporating a curved device/device with a curved surface where rope means is suspended to for converting the vertical movements of vessel (102) or payload (101), to horizontal movements of the actuator piston rod (13) compensating the load (101). The transportable inline heave compensator (100) comprises an active part which is self supported and not connected to the vessel (102). With self supported is to be understood that the compensator has an active part which not have to be coupled to the vessel.

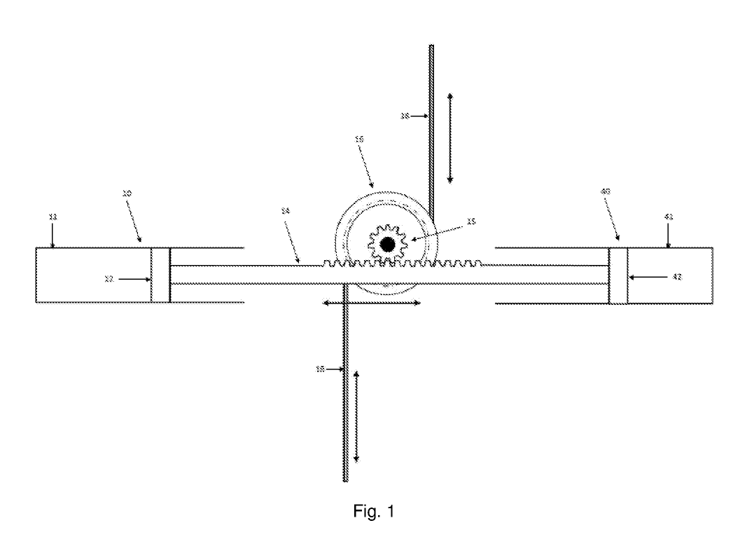

FIG. 1 illustrates how the drum (16) rotation is transferred into linear motion via a rack (14) and pinion (15). The rack (14) is connected to pistons (12, 42) at each end. The two rope means (18) shown are connected to the crane hook and to the payload (101) respectively. The weight of the payload (101) generates torque on the drum (16) which is transferred as a linear force to the rack (14) via the pinion (15). “stroke” is increasing when the drum (16) is rotating counter clockwise and reducing when it is rotating clockwise. The actuators (10, 40) can be with or without stuffing box, in any case they compensate water pressure as they have an equal area on either rod (rack (14)) or piston (12, 42) or both. Pressure from a passive and active system is applied to the actuators (10, 40) to counteract the force from the drum (16) torque.

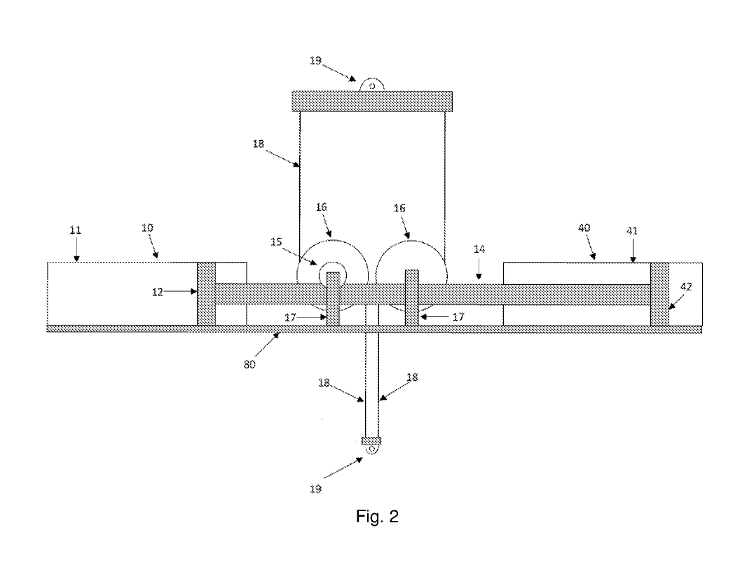

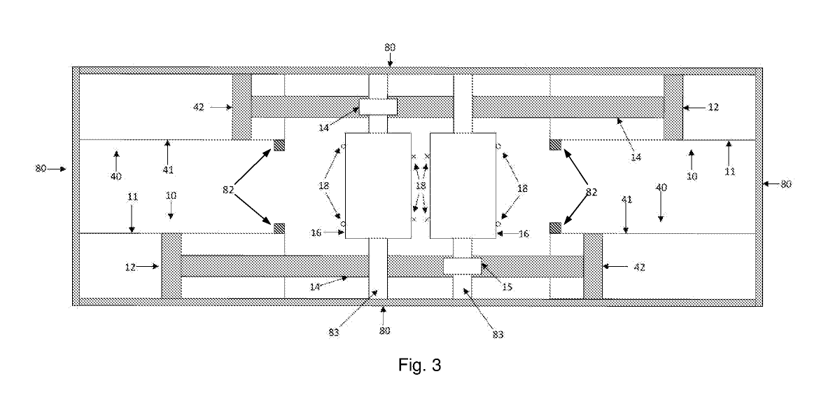

FIG. 2 illustrates a two drum (16) version of the transportable inline heave compensator (100), seen from the side, while FIG. 3 shows a two drum (16) version seen from the top. Accumulators, tanks and other parts are not shown. The two drum version makes it easy to get the centre of gravity in the middle of the transportable inline heave compensator (100) and it will not change with drum (16) angle. Two actuators (10, 40) are used per drum (16), however it seems feasible to use just two actuators (10, 40) in total if an extra pinion (15) is used to get the correct rotational direction (i.e. The drums should rotate opposite of each other). The rope means (18) from the drums (16) are connected together using construction means (81) and have connection device (19) fitted so that i.e. Shackles can be connected. Construction means (80) forms a stiff connection between the actuators (10, 40) and the bearing means (17) used to support the drum (16) axles (83). If long “stroke” is not needed, then it's possible to connect either the crane hook or payload (101) to the alternative connection device (82).

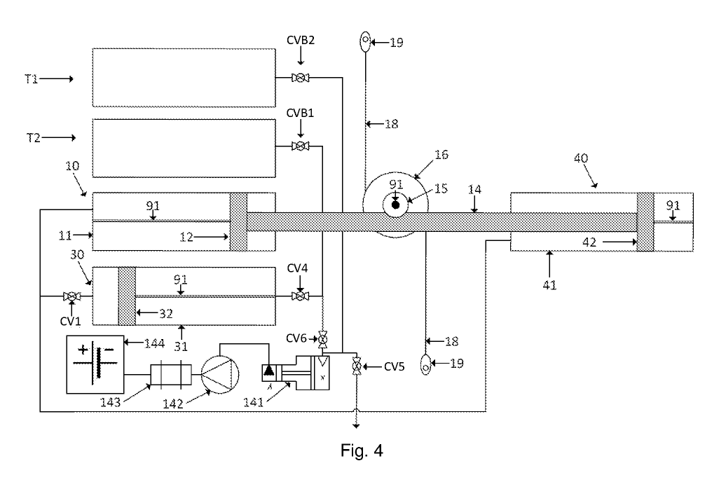

FIG. 4 shows a schematic for a passive transportable inline heave compensator (100). For simplicity only one drum (16) is shown, but more than one may be used. Clockwise rotation of the drum (16) causes one or more rope means (18) to be spooled off the drum (16) when force is applied to the connection device (19). A pinion (15) is connected to the drum (16) and converts rotational motion of the drum (16) to linear motion of the rack (14). The rack (14) in turn is connected to two pistons (12, 42) located inside two actuators (10, 40). Piston side on one actuator should be connected to rod side on the other actuator. This can be done in two ways, the way shown in FIG. 4 is suitable for clockwise rotation of the drum (16) (to increase torque), while the opposite way is suitable for counter clockwise rotation of the drum (16) (to increase torque). A conduit means connects the two actuators (40, 10) to the first accumulator (30) via a valve means (CV1). The valve means (CV1) is used to block or partially block the flow of hydraulic fluid from the actuators (10, 40) to the first accumulator (30). The first accumulator (30) contains a piston (32) which separates hydraulic fluid from gas. Conduit means further connects the gas side of the first accumulator (30) to a first tank (T1) via valve means (CV4, CVB1), which may be independently closed, partially closed or fully open. The first tank (T1) can be used as a gas storage vessel or to increase the gas volume of the first accumulator (30). A second tank (T2) is used to store high pressure gas.

A means for gas transportation (140), consisting of a pressure intensifier (141), connected to a pump (142), connected to a motor (143), connected to an energy source (144), is used to transport gas between the first accumulator (30), the first tank (T1), the second tank (T2) and the surroundings. The means for gas transportation (140) enables transport of gas even when there is a negative differential pressure. Valve means (CV6, CV5, CVB2) are used to control gas flow in and out of the means for gas transportation (140). Drum angle sensor(s) (91), which may be located in one or both of the actuators (10, 40), the first accumulator (30) or on the drum (16) is used to measure the “stroke” of the transportable inline heave compensator (100) as a function of the angle of the drum (16).

FIG. 5 shows a schematic for an active transportable inline heave compensator (100). For simplicity, only one drum (16) is shown, but more than one may be used. Clockwise rotation of the drum (16) causes one or more rope means (18) to be spooled off the drum (16) when force is applied to the connection device (19). A pinion (15) is connected to the drum (16) and converts rotational motion of the drum (16) to linear motion of the rack (14). The rack (14) in turn is connected to two pistons (12, 42) located inside two actuators (10, 40). The piston side of one actuator is connected to the first accumulator (30) via a valve means (CV1). The valve means (200) is used to block or partially block the flow of hydraulic fluid from the actuators (10, 40) to the first accumulator (30). The first accumulator (30) contains a piston (32) which separates hydraulic fluid from gas. Conduit means further connects the gas side of the first accumulator (30) to a first tank (T1) via valve means (CV4, CVB1), which may be independently closed, partially closed or fully open. The first tank (T1) can be used as a gas storage vessel or to increase the gas volume of the first accumulator (30). A second tank (T1) is used to store high pressure gas. The rod or piston side or both of the other actuator (in this example 40) is connected to a pressure intensifier (170) via conduit means. The pressure intensifier consists of two cylinder (173, 174), a piston (172) and a rod (171). It is used to increase the flow rate of the means for hydraulic fluid transportation (180) by a ratio equal to the area ratio of the piston (172) and rod (171). The means for hydraulic fluid transportation (180) is connected to a second accumulator (60), which contains both oil and gas separated by a piston (62), via conduit means. The means for hydraulic fluid transportation (180) is powered by a motor (181) that gets energy from an energy source (144), which may be a battery pack or an energy source located on the vessel (3). The means for hydraulic fluid transportation (180) is controlled based on measurements from the drum angle sensor (91), the accelerometer (92) and/or the water pressure sensor (94) and/or the communication means (110). The communication means (145) transfers information about crane motion and/or crane winch spooling to the transportable inline heave compensator (100).

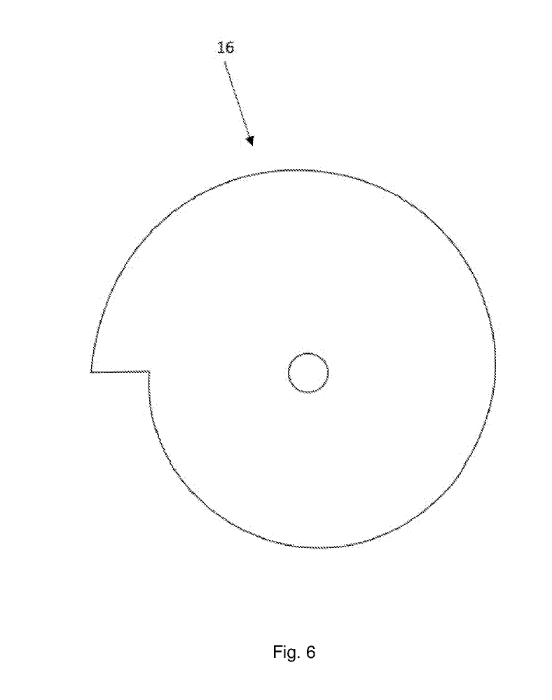

FIG. 6 shows a drum (16) with variable diameter versus rotational angle. The variable diameter can reduce the need for gas volume significantly as almost constant torque can be achieved by varying the moment arm in the same way as the gas pressure varies during compression. The result is close to constant torque versus rotational angle, which significantly increases the performance of the passive system and reduces the energy need for the active system.

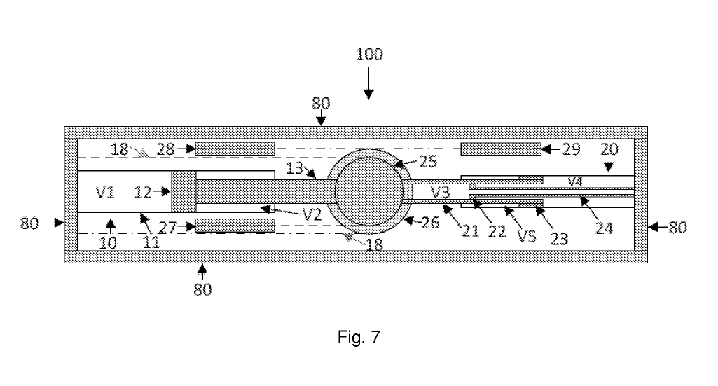

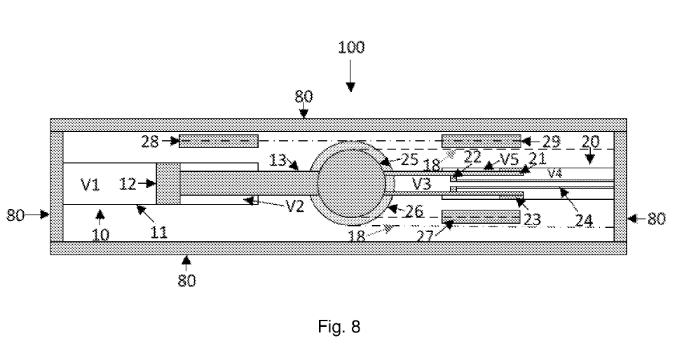

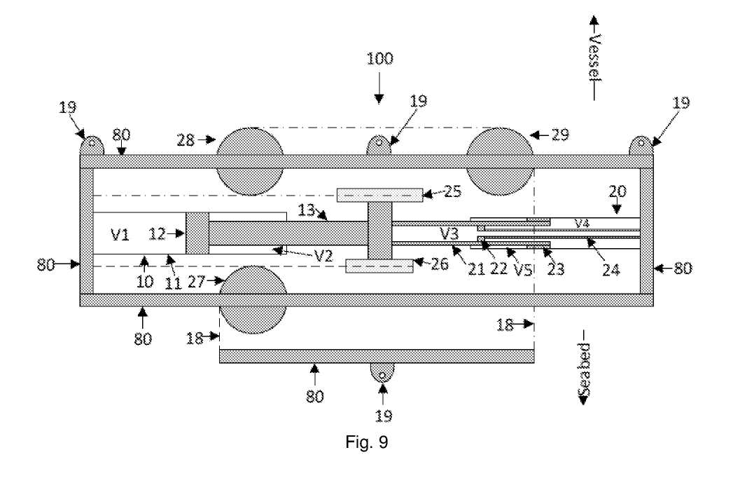

FIGS. 7 and 9 illustrate an embodiment of a compression-based transportable inline heave compensator (100) actuator (10) with horizontal sheaves (25, 26) attached to the actuator rods (13, 21) with all major sub-components numbered seen from the above and from the side, it does not depict accumulators, tanks or other components. FIG. 8 shows a similar, but tension-based design. Horizontal sheaves (25, 26) reduce the vertical size of the transportable inline heave compensator (100) as the other sheaves (27, 28, 29)) can be mounted further up, hence reducing the minimum vertical size of the transportable inline heave compensator (100).

The actuator (10) consists of an active actuator cylinder (20) and a passive actuator cylinder (11), that are collinear with each other as well as horizontal.

The active actuator cylinder (20) comprises a first hollow piston rod (21), connected to a first piston (23), a second hollow piston rod (24) connected to a second piston (22), where the second hollow piston rod (24) and the second piston (22) are mounted concentrically inside the first hollow piston rod (21) and fixed to one end of the active actuator cylinder (20). The active actuator cylinder (20) has three separate volumes, designated V3, V4 and V5. V3 is located between; the inside of the first hollow piston rod (21), the inside of the second piston rod (24), the top of the second piston (22) as well as the end of the actuator cylinder (20) and is filled with hydraulic fluid. V4 is located between; the inside of the first hollow piston rod (21), the outside of the second piston rod (24), the bottom of the second piston (22) and the first piston (23) as well as the end and inside diameter of the actuator cylinder (20) and is filled with a low pressure gas (including vacuum). V5 is located between; the outside of the first hollow piston rod (21), the top of the first piston (23) as well as the end and inside diameter of the actuator cylinder (20) and is filled with a hydraulic fluid.

The passive actuator cylinder (11) comprises a third piston (12) connected to a piston rod (13) and has two volumes, designated V1 and V2, where V1 is on the piston side and V2 is on the rod side. The volumes are filled differently, depending on if the passive actuator cylinder (11) is working in tension or compression mode, where V1 is filled with hydraulic fluid and V2 is either filled with oil or filled with low pressure gas (including vacuum) when working in compression mode and where V2 is filled with hydraulic fluid and V1 is either filled with oil or filled with low pressure gas (including vacuum) when working in tension mode. At least one of the two volumes is connected to a gas accumulator (30).

The active and passive actuator cylinders (11, 20) have equal stroke length, the piston rods (13, 21) are joined together and should preferably have the same diameter to cancel water pressure effects. In the joint area between the piston rods (13, 21) a set of actuator sheaves (25, 26) are mounted.

The actuator further contains framework (80) joining the two actuator cylinders (10, 20) together in a stiff connection. The framework (80) may partly consist of tanks and accumulators to reduce weight. The framework (80) is further fitted with connection device (19) used to connect the transportable inline heave compensator (100) to a crane, or similar, located on a vessel (102), where the connection device (19) may be located in the centre of gravity of the transportable inline heave compensator (100) or at other locations as shown in FIG. 9. The framework (80) further supports three secondary sheaves (27, 28, 29), used to support rope means (18), such as steel wire rope, fibre rope, belt, chain or similar, connecting the actuator sheaves (25, 26) to the lower connection device (19), which in turn is connected to the payload (101). The rope means (18) are reeved over the actuator sheaves (25, 26) and the secondary sheaves (27, 28, 29), with one end connected to a fixed point, such as the framework (80) and the other end connected to the payload (101) via a lower connection device (19). Lowering of the payload (101) relative to the transportable inline heave compensator (100) causes the actuator sheaves (25, 26) to move horizontally, the direction (i.e., towards or away from the active actuator cylinder (20)) depending on if the transportable inline heave compensator (100) is compression or tension-based. Lowering of the payload (101) will cause the pressure in the gas accumulator (30) to increase. The force acting on the actuator (10) is at least twice of the force in the rope means (18), depending on the number of falls used.

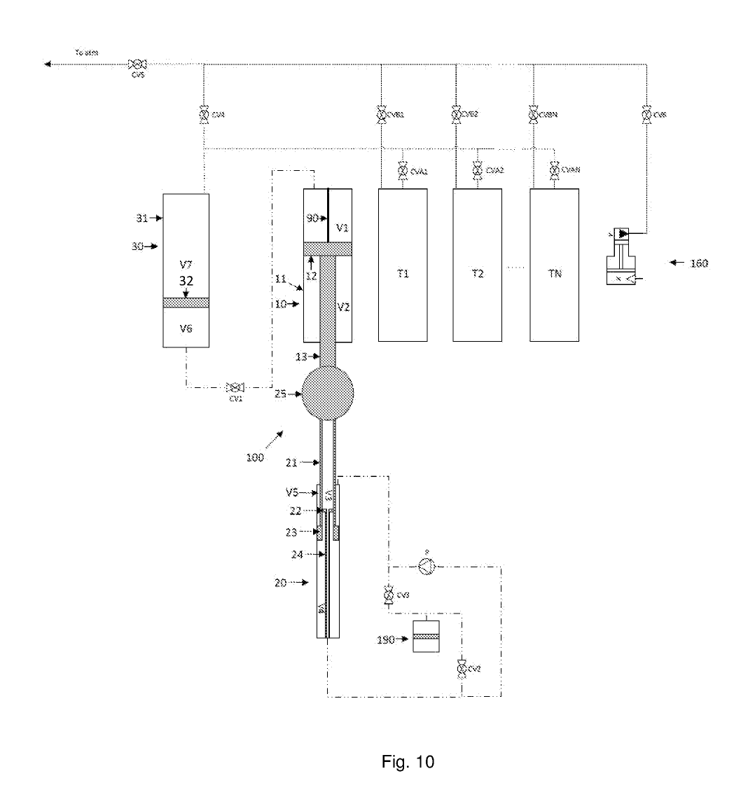

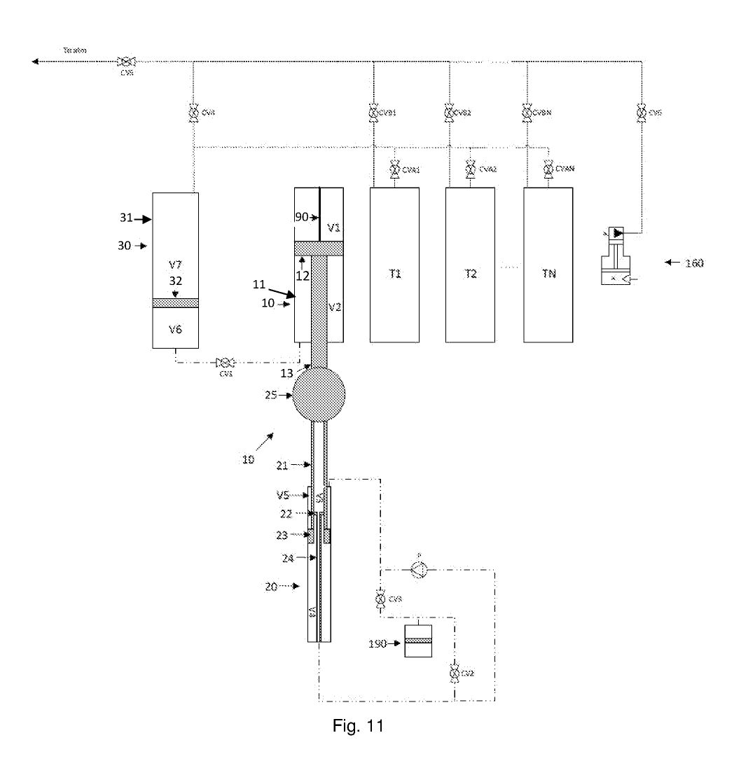

FIGS. 10 and 11 are very similar and shows simplified hydraulic circuits of compression and tension based transportable inline heave compensator (100). They are both described below:
An actuator (10), comprising of an active actuator cylinder (20) and a passive actuator cylinder (11), which longitudinal axes are collinear
The active actuator cylinder (20) comprises a first hollow piston rod (21), connected to a first piston (23), a second hollow piston rod (24) connected to a second piston (22), where the second hollow piston rod (24) and the second piston (22) are mounted concentrically inside the first hollow piston rod (21) and fixed to one end of the active actuator cylinder (20), the active actuator cylinder (20) has three separate volumes, designated V3, V4 and V5; V3 is located between: the inside of the first hollow piston rod (21), the inside of the second piston rod (24), the top of the second piston (22) as well as the end of the actuator cylinder (20) and is filled with hydraulic fluid; V4 is located between; the inside of the first hollow piston rod (21), the outside of the second piston rod (24), the bottom of the second piston (22) and the first piston (23) as well as the end and inside diameter of the actuator cylinder (20) and is filled with a low pressure gas (including vacuum); V5 is located between; the outside of the first hollow piston rod (21), the top of the first piston (23) as well as the end and inside diameter of the actuator cylinder (20) and is filled with a hydraulic fluid
The passive actuator cylinder (11) comprises a third piston (12) connected to a piston rod (13) and has two volumes, designated V1 and V2, where V1 is on the piston side and V2 is on the rod side, the volumes are filled differently, depending on if the passive actuator cylinder (11) is working in tension or compression mode, where V1 is filled with hydraulic fluid and V2 is either filled with oil or filled with low pressure gas (including vacuum) when working in compression mode and where V2 is filled with hydraulic fluid and V1 is either filled with oil or filled with low pressure gas (including vacuum) when working in tension mode, one of the two volumes are connected to a gas accumulator (30)
A position measurement means (90) to register the position of the third piston 12)
A gas accumulator (30), featuring a fourth piston (32) that separates fluid, containing two volumes designated V6 and V7, where V6 is connected to v1 in the passive actuator cylinder (11) if operating in compression mode and to V2 in the passive actuator cylinder (11) if operating in tension mode, via conduit means adapted with a control valve (CV1), filled with hydraulic fluid and where V7 is filled with gas
A gas booster (160), which can be of either single acting or double acting type, with or without area difference between gas and drive side, including means to drive it, which could be either hydraulic- or gas-based
A number of tanks (T1, T2, . . . , TN) suitable for gas storage
Conduit means between V3 and V5 adapted with a hydraulic pump (P) adapted to transport oil under pressure between the respective volumes in any direction, adapted with control valves (CV2, CV3) and a gas accumulator (190) suitable for handling pump leakage and providing low flow restriction when the transportable inline heave compensator (100) is used in passive mode
Conduit means between V7 and the tank volumes (T1, T2, . . . , TN) adapted with control valves (CVA1, CVA2, CVAN) for adjustment of the volume size connected to V7
Conduit means between all gas volumes (V7, T1, T2, . . . , TN), the gas booster (160) as well as the surroundings, adapted with control valves (CV4, CV5, CV6, CVB1, CVB2, . . . , CVBN), suited for pressure adjustment, both up and down, in all volumes as well as filling from the surroundings or release of pressure to the surroundings.

The transportable inline heave compensator (100) further features a sensing means adapted for measuring the vertical motion of the transportable inline heave compensator (100), one or more sensing means adapted for measuring the pressure in one or more volume, a computer adapted for controlling the pump (P), the gas booster (160) and the control valves (CV) based on input from the sensing means, communication means adapted to transfer signals between the vessel (102) and the transportable inline heave compensator (100), preferably with acoustic communication while subsea and wirelessly while in air and either a battery pack or an umbilical cable for energy supply.

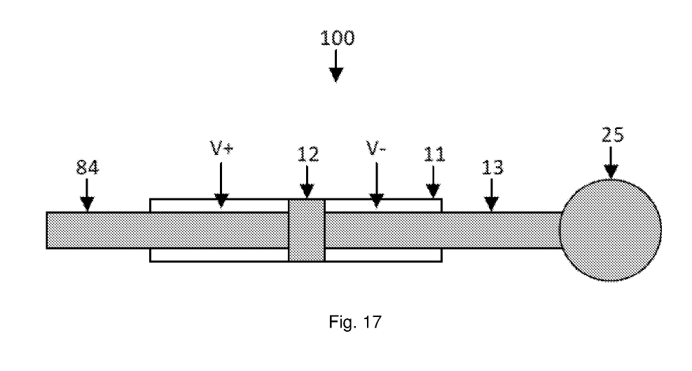

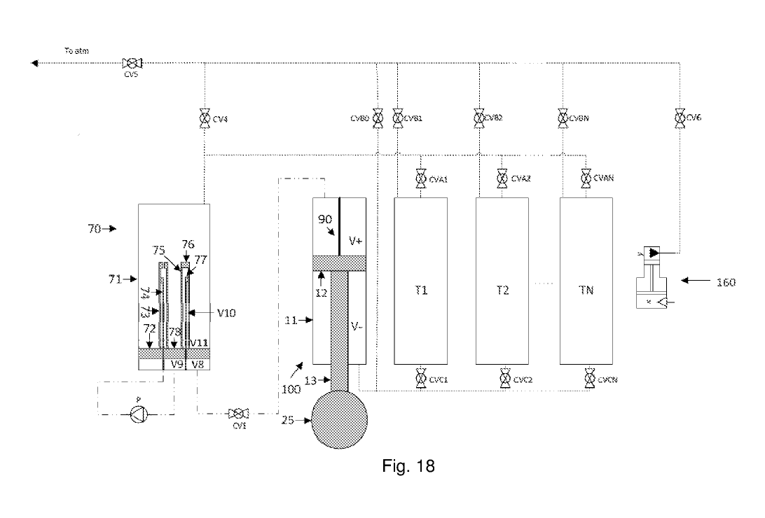

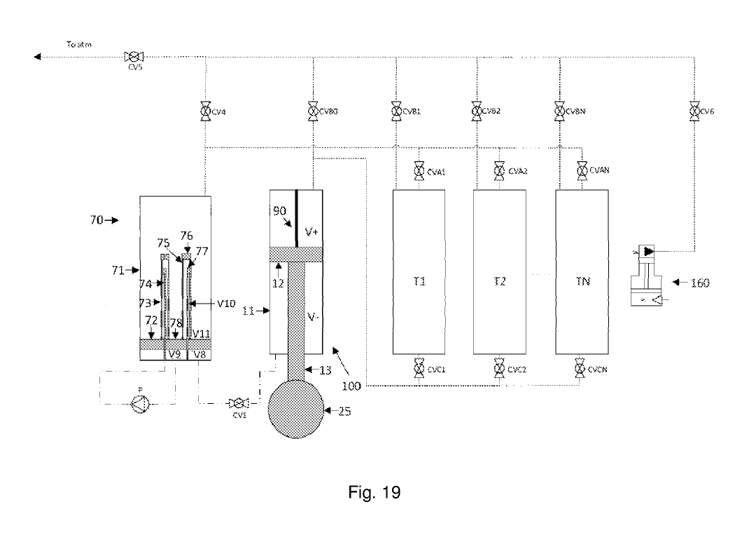

Decrease in temperature and increase of water pressure is handled by the transportable inline heave compensator (100) in different ways:
1. The actuator (10) shown in FIG. 17 is passive depth compensated, which effectively cancels the water pressure effect by having tail rods (84) passing through the actuator cylinders (11) with the same diameter as the actuator rods (13).
2. The transportable inline heave compensators (100) shown in FIG. 18 and FIG. 19 has an active depth compensation system that adjusts pressure on both sides of the actuator pistons (12) so that the water pressure effect is cancelled. The system is controlled by the on-board computer and can in many cases provide better performance than the passive depth compensation, however the passive version is more robust and less complex.

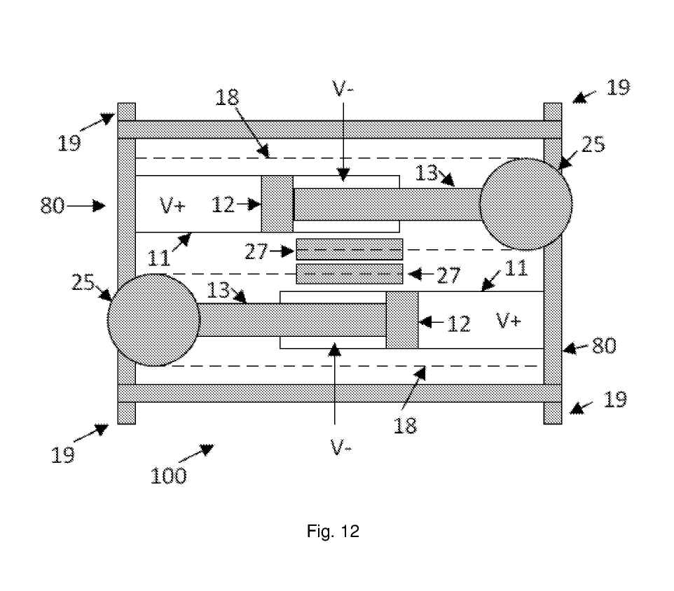

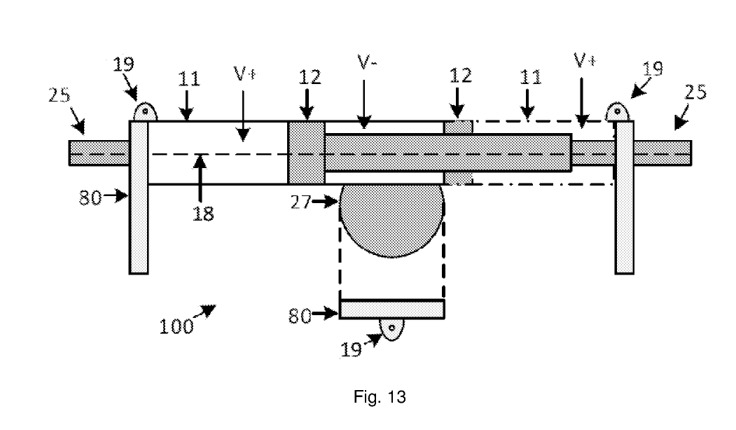

FIGS. 12 and 13 illustrates an embodiment of a compression based-transportable inline heave compensator (100) actuator (10) with horizontal sheaves (25) attached to the actuator rods (13) with all major sub-components numbered seen from the above and from the side, it does not depict accumulators, tanks or other components. A compression based design allows for a more compact transportable inline heave compensator (100) in the horizontal direction compared to tension based designs as the actuator cylinders (11) can be partially adjacent to each other. Horizontal sheaves (25) reduces the vertical size of the transportable inline heave compensator (100) as the other sheaves (27) can be mounted further up, hence reducing the minimum vertical size of the transportable inline heave compensator (100).

The actuator (10) consists of minimum two actuator cylinders (11), each with an actuator piston (12) and an actuator rod (13) connected to the actuator piston (12) in one end and a horizontal sheave (25) in the other end, a framework (80) locking the actuator cylinders in position relative to each other as well as providing support for the sheaves (27) and acting as a support for the-transportable inline heave compensator (100) when not in use (i.e. Placed on the vessel deck), at least two rope means (18) (i.e. Wire rope, fibre rope, chain, belt or similar) attached to a fixed point (e.g. Framework (80)) in one end and connected to the payload (101) in the other end and being reeved over the actuator sheaves (25) and the other sheaves (27), connection device (19) used for connecting the-transportable inline heave compensator (100) to the crane and to the payload (101) via connection device (19) attached to a framework (80) attached to the minimum two rope means (18). The actuator cylinders (11) have two volumes each, the first volume (V+) is used for extending the actuator rod (13), and the second volume (V−) can be used for e.g. Active depth compensation or end damping. The first volume (V+) is normally connected to double acting gas accumulator(s) and is normally filled with oil.

When tension is applied to the rope means (18) a force will act on the actuator rod (13) via the actuator sheave (25) which in turn will be transferred to the first volume (V+) as pressure via the actuator piston (12). The figure shows a rope means (18) configuration which gives double the movement of the rope means (18) compared to the actuator cylinder (11) stroke. This can be increased by increasing the number of rope means (18) falls. Also the force acting on the actuator cylinder (11) is twice of the force in the rope means (18).

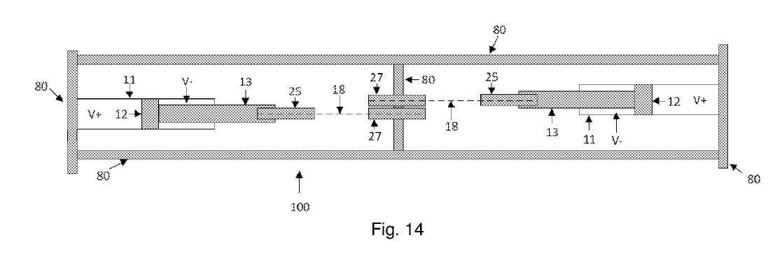

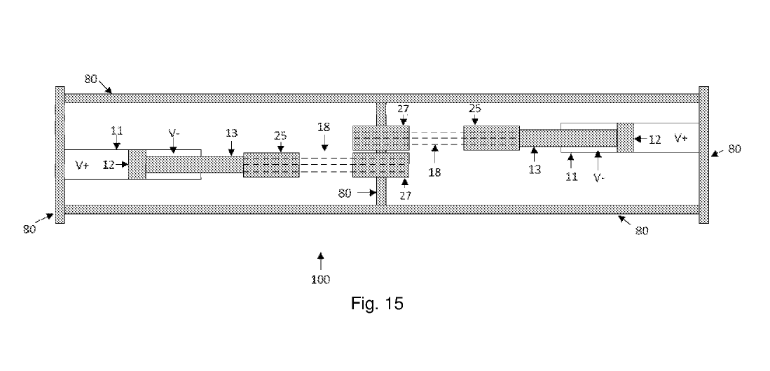

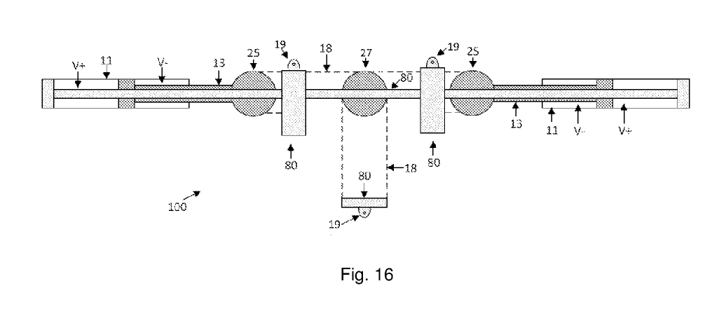

FIG. 14-16 illustrates embodiments of a tension based transportable inline heave compensator (100) actuator (10) with vertical sheaves (25) attached to the actuator rods (13) with all major sub-components numbered, it does not depict accumulators, tanks or other components. A tension based design allows for use of smaller diameter actuator rods (13) compared to compression based designs. It is also easy to implement multiple falls, and hence easy to increase the ratio between the lower connection device (19) (i.e. Connected to the payload (101)) movement and the actuator rod (13) movement. The force acting on the actuator cylinder (11) is also multiplied with the same ratio. A single fall design is shown in FIG. 14 and a multi fall design is shown in FIG. 15.

The actuator (10) consists of minimum two actuator cylinders (11), each with an actuator piston (12) and an actuator rod (13) connected to the actuator piston (12) in one end and an actuator sheave (25) in the other end, a framework (80) locking the actuator cylinders in position relative to each other as well as providing support for the sheaves (27), at least two rope means (18) (i.e. Wire rope, fibre rope, chain, belt or similar) attached to a fixed point (e.g. Framework (80)) in one end and connected to the payload (101) in the other end and being reeved over the actuator sheaves (25) and the other sheaves (27), connection device (19) used for connecting the transportable inline heave compensator (100) to the crane. The actuator cylinders (11) have two volumes each, the first volume (V+) is used for e.g. Active depth compensation or end damping, and the second volume (V−) is used to retract the actuator rod (13). The second volume (V−) is normally connected to double acting gas accumulator(s) and is normally filled with oil.

When tension is applied to the rope means (18) a force will act on the actuator rod (13) via the actuator sheave (25) which in turn will be transferred to the second volume (V−) as pressure via the actuator piston (12).

FIG. 17 shows an actuator cylinder (11) with passive depth compensation. The actuator cylinder (11) has a piston (12) connected to a piston rod (13) and a tail rod (84), both rods (13, 84) have the same diameter, so that when external pressure is applied to the rods (13, 84) the net force will be zero. This principle can be used in any of the embodiments.

FIGS. 18 and 19 are very similar and shows simplified hydraulic circuits of compression and tension based transportable inline heave compensators (100). They are both described below:
A hydraulic actuator (10), comprising of minimum two actuator cylinders (11) consisting of an actuator rod (13) connected to an actuator piston (12) and extending outwardly therefrom through one end of the actuator cylinder (11), adapted for reciprocation with respect thereto, actuator sheave (25) mounted at one end of the actuator rod (13) adapted for applying force to rope means (18), a first actuator volume (V+), located between the actuator piston (12) and piston side of the actuator cylinder (11), filled with oil for compression based designs and filled with gas (at any pressure, including vacuum) on tension based designs, a second actuator volume (V−), located between the actuator piston (12) and rod side of the actuator cylinder (11), filled with oil on tension based designs and filled with gas (at any pressure, including vacuum) on compression based designs, a position measurement means (90) to register the position of the actuator piston (12)
A double acting gas accumulator (70), comprising of a first cylinder (71), a ring shaped piston (72) mounted concentrically within the first cylinder (71) and adapted for reciprocation with respect thereto, where the lower end of the ring shaped piston (72) is on the same side as the lower end of the first cylinder (31) when the ring shaped piston (72) is at zero stroke, a first inner cylinder (73) mounted concentrically with and fixed to the upper end of the ring shaped piston (72), a second inner cylinder (74) mounted concentrically within the first cylinder (71) and fixed to the lower end of the first cylinder (71) with a leak tight connection against the lower end of the first cylinder (71) as well as a leak tight seal against the ring shaped piston (72), an inner piston (78) mounted concentrically within the first inner cylinder (74) with a leak tight seal against the first inner cylinder (74) where the lower end of the inner piston (78) is at the same level as the lower end of the ring piston (78), a third inner cylinder (75) mounted concentrically within the first cylinder (71) and fixed to the upper end of the inner piston (78) and to a cylinder connector (76) that joins the third inner cylinder (75) with the first inner cylinder (73) in a stiff connection, a stuffing box (77) is mounted on top of the second inner cylinder (74) to form a leak tight connection with the first inner cylinder (73), the cylinder connector (76) has openings that allow free flow of fluids to either side of the cylinder connector (76), the second inner tube (74) is equipped with means for transporting fluid from outside the double acting gas accumulator (70) to the volume (V10) between the first inner tube (73) and the second inner tube (74), a first volume (V8), located between the lower end of the ring piston (72), the lower end of the first cylinder (71) and the outside of the first inner cylinder (74), a second volume (V9), located between the lower end of the inner piston (78), the lower end of the first cylinder (71) and the inside of the second inner cylinder (74), a third volume (V10), located between the upper end of the ring piston (72), the outside of the first second cylinder (74), the inside of the first inner cylinder (74) and the lower end of the stuffing box, a fourth volume (V11), contains the remaining volume of the double acting accumulator (70) not occupied by any parts or any other volumes
A gas booster (160), which can be of either single acting or double acting type, with or without area difference between gas and drive side, including means to drive it, which could be either hydraulic or gas based
A number of tanks (T1, T2, . . . , TN) suitable for gas storage
Conduit means between the first actuator volume (V+) and the first volume (V8) for compression based designs and conduit means between the second actuator volume (V−) and the first volume (V8) for tension based designs, adapted with a control valve (CV1)
Conduit means between the second volume (V9) and the third volume (V10) adapted with a hydraulic pump (P) adapted to transport oil under pressure between the respective volumes in any direction
Conduit means between the fourth volume (V11) and the tank volumes (T1, T2, . . . , TN) adapted with control valves (CVA1, CVA2, CVAN) for adjustment of the volume size connected to the fourth volume (V11)
Conduit means between the first actuator volume (V+), for tension based designs, and between the second actuator volume (V−), for compression based designs, and any number of tank volumes (T1, T2, . . . , TN), adapted with control valves (CVC1, CVC2, CVCN) for adjustment of the volume size connected to the actuator
Conduit means between all gas volumes (V4, V+ for tension based designs, V− for compression based designs, T1, T2, . . . , TN), the gas booster (160) as well as the surroundings, adapted with control valves (CV4, CV5, CV6, CVB0, CVB1, CVB2, CVBN), suited for pressure adjustment, both up and down, in all volumes as well as filling from the surroundings or release of pressure to the surroundings.

FIG. 20 shows the transportable inline heave compensator (100) during a lift of a payload (101) from a barge (103). A wireless MRU (105) adapted for transferring motion data to the transportable inline heave compensator (100) is used in combination with either an internal MRU or a second external MRU (104) as well as transmission of winch spooling data to calculate actuator rod (13) speed to ensure that the relative motion between the lower end of the transportable inline heave compensator (100) and the barge (103) deck is close to zero, except for winch spooling, this enables safe and efficient connection between the transportable inline heave compensator and the payload as well as safe lift off. Actuator (10) pressure is adjusted, by transfer of gas between tanks (T1, T2, . . . , T3) and the double acting gas accumulator (30), to match the actual payload weight.

FIG. 21 shows the transportable inline heave compensator (100) during a subsea lift of a payload (101). For most of the time, while in transit from the splash zone to a short time before landing, the transportable inline heave compensator (100) is in passive mode, i.e. There is no influence on the system from the pump (free flow). The transportable inline heave compensator (100) can be put into active mode by several means, e.g. Based on water depth, time, turning an ROV switch or by acoustic communication. While in active mode the transportable inline heave compensator (100) will minimize the relative motion between the lower end of the transportable inline heave compensator (100) and the seabed (106) to ensure a safe and controlled landing. Winch spooling data is preferably transferred to the transportable inline heave compensator (100) via acoustic communication or via an umbilical to remove crane operator lag.

The transportable inline heave compensator (100) further features a sensing means adapted for measuring the vertical motion of the transportable inline heave compensator (100), one or more sensing means adapted for measuring the pressure in one or more volume, a computer adapted for controlling the pump (P), the gas booster (160) and the control valves (CV) based on input from the sensing means, communication means adapted to transfer signals between the vessel (102) and the transportable inline heave compensator (100), preferably with acoustic communication while subsea and wirelessly while in air and either a battery pack or an umbilical for energy supply.

| Comp. | Description |
|---|---|
| 10 | Actuator |
| 11 | Actuator cylinder |
| 12 | Actuator piston |
| 13 | Actuator rod |
| 14 | Rack |
| 15 | Pinion |
| 16 | Drum |
| 17 | Bearing means |
| 18 | Rope means |
| 19 | Connection device |
| 20 | Active actuator cylinder |
| 21 | Piston rod |
| 22 | Piston |
| 23 | First piston |
| 24 | Second hollow piston rod |
| 25 | Actuator sheave |
| 26 | Actuator sheave |
| 27 | Secondary sheave |
| 28 | Secondary sheave |
| 29 | Secondary sheave |
| 30 | Accumulator |
| 31 | Accumulator cylinder |
| 32 | Accumulator piston |
| 40 | Second actuator |
| 41 | Second actuator cylinder |
| 42 | Second actuator piston |
| 43 | Second actuator rod |
| 60 | Second accumulator |
| 61 | Second accumulator cylinder |
| 62 | Second accumulator piston |
| 70 | Double acting accumulator |
| 71 | First cylinder |
| 72 | Ring shaped piston |
| 73 | First inner cylinder |
| 74 | Second inner cylinder |
| 75 | Third inner cylinder |
| 76 | Cylinder connector |
| 77 | Stuffing box |
| 78 | Inner piston |
| 80 | Framework |
| 81 | Construction means |
| 82 | Connection device |
| 83 | Axel |
| 84 | Tailrod |
| 90 | Position sensor |
| 91 | Drum angle sensor |
| 92 | Accelerometer |
| 93 | Pressure sensor |
| 94 | Water pressure sensor |
| 100 | Compensator |
| 101 | Payload |
| 102 | Vessel |
| 103 | Barge |
| 104 | Second MRU |
| 105 | First MRU |
| 106 | Seabed |
| 140 | Means for gas transportation |
| 141 | Pressure intensifier |
| 142 | Intensifier pump |
| 143 | Pump motor |
| 144 | Energy source |
| 145 | Communication means |
| 160 | Gas booster |
| 170 | Pressure intensifier |
| 171 | Intensifier rod |
| 172 | Intensifier piston |
| 173 | First intensifier cylinder |
| 174 | Second intensifier cylinder |
| 180 | Means for hydraulic transportation/Pump |
| 181 | Pump motor |
| 190 | Gas accumulator |
| P | Pump motor |
| CV1, CV2, . . . , CVN | Control valve |
| CVA1, CVA2, . . . , CVAN | Control valve |
| CVB1, CVB2, . . . , CVBN | Control valve |
| T1 | First tank |
| T2 | Second tank |
| TN | N'th tank |

1. A transportable inline heave compensator provided with connection devices for suspending the compensator from a load bearing device and a connection device for a carrying a payload,
wherein the compensator, comprising a passive heave compensator part and possibly an active heave compensator part, and being provided with a sensor arrangement, where the compensator further comprises at least one actuator, that is horizontally oriented in operation and comprises an actuator piston rod with a horizontally stroke indirectly connected to a rope means, where the rope means at an end, via a connection device, such as a padeye, is connected to at least one of; a vessel at the sea surface or a payload, incorporating a device with a curved surface where rope means is suspended to for converting the vertical movements of vessel or payload, to horizontal movements of the actuator piston rod compensating the load.

2. A transportable inline heave compensator according to claim 1, wherein the compensator comprises an active part which is self supported and not connected to the vessel.

3. A transportable inline heave compensator according to claim 2, wherein elements incorporated in the compensator are in fixed position and relation to each other as elements are directly or indirectly fixed to a framework.

4. A transportable inline heave compensator according to claim 3, wherein rope means preferably comprises steel wire rope, fiber rope, chain belt or similar.

5. A transportable inline heave compensator according to claim 4, wherein the compensator comprises at least one gas accumulator, comprising a cylinder, a piston separating oil/hydraulic fluid from gas, fluidly connected to the actuator at either rod side or piston side of the actuator.

6. A transportable inline heave compensator according to claim 5, wherein the actuator comprises a horizontally oriented actuator cylinder and an actuator piston located inside the cylinder and adapted for reciprocation with respect thereto and a piston rod connected to the actuator piston and extending outwardly and through one end of the actuator cylinder.

7. A transportable inline heave compensator according to claim 6, wherein the compensator further comprises a valve means used to block or partially block flow of oil/hydraulic fluid between actuator and accumulator.

8. A transportable inline heave compensator according to claim 7 wherein the compensator further comprises minimum one gas tank (T1, T2, . . . , TN) connected to gas side of gas accumulator via conduit means, adapted with control valves (CVA1, CVA2, . . . , CVAN, CVB0, CVB1, . . . , CVBN, CV4) for adjustment of the gas volume in accumulator.

9. A transportable inline heave compensator according to claim 8 wherein the actuator comprises minimum two horizontally mounted actuator cylinders, wherein each actuator cylinder comprises an actuator rod connected to an actuator piston.

10. A transportable inline heave compensator according to claim 9, wherein the incorporated curved device/device with a curved surface is minimum one actuator sheave, wherein actuator sheaves are connected at the end of the actuator piston rods.

11. A transportable inline heave compensator according to claim 10 wherein the two horizontally mounted actuator cylinders comprise a passive actuator cylinder and an active actuator cylinder.

12. A transportable inline heave compensator according to claim 11 wherein the first actuator cylinder which is a passive actuator cylinder, where piston divides cylinder into two volumes, designated V1 and V2, where V1 is on the piston side and V2 is on the rod side, the volumes are filled differently, depending on if the passive actuator cylinder is working in tension or compression mode, where V1 is filled with hydraulic fluid and is connected to the gas accumulator via conduit means and V2 is either filled with oil or filled with low pressure gas (including vacuum) when working in compression mode and where V2 is filled with hydraulic fluid and is connected to the gas accumulator via conduit means and V1 is either filled with oil or filled with low pressure gas (including vacuum) when working in tension mode;
wherein the second actuator cylinder which is an active actuator cylinder, including a piston rod, and the passive actuator cylinder have collinear longitudinal axes that are horizontal, where the respective piston rods are fixed together in a stiff connection with actuator sheaves at the connection point;
further comprising a position measurement means to register the position of the piston;
wherein the gas accumulator, featuring the piston that separates two volumes designated V6 and V7, where V6 is connected to V1 in the passive actuator cylinder if operating in compression mode and to V2 in the passive actuator cylinder if operating in tension mode, via conduit means adapted with a control valve, filled with hydraulic fluid and where V7 is filled with gas;
the actuator comprising a framework joining the elements together in a stiff connection, where the framework may partly consist of tanks and accumulators to reduce weight, the framework is further fitted with connection device used to connect the compensator to a crane, or similar, located on a vessel, where the connection device may be located in the centre of gravity of the compensator or at other locations, the framework further supports three secondary sheaves, used to support rope means, such as steel wire rope, fiber rope, belt, chain or similar, connecting the actuator sheaves to the lower connection device, which in turn is connected to the payload, the rope means are reeved over the actuator sheaves and the secondary sheaves, with one end connected to a fixed point, such as the framework and the other end connected to the payload via a lower connection device, lowering of the payload relative to the compensator causes the actuator sheaves to move horizontally, the direction (i.e., towards or away from the active actuator cylinder) depending on if the compensator is compression or tension based;
further comprising an accelerometer integrated into the compensator, adapted for measuring vertical motion;
further comprising communication means, such as wireless communication while in air and acoustic communication while submerged, adapted for transmitting data from the vessel such as commands and winch spooling speed, to the compensator;
further comprising a hydraulic motor, which is reversible, adapted to actuate the active actuator cylinder, based on measurement data from the position sensor, the accelerometer and the measurement data from the vessel, such as winch spooling speed.

13. A transportable inline heave compensator according to claim 12,
wherein the active actuator cylinder comprises a first hollow piston rod, connected to a first piston, a second hollow piston rod connected to a second piston, where the second hollow piston rod and the second piston are mounted concentrically inside the first hollow piston rod and fixed to one end of the active actuator cylinder, the active actuator cylinder has three separate volumes, designated V3, V4 and V5; V3 is located between: the inside of the first hollow piston rod, the inside of the second piston rod, the top of the second piston as well as the end of the actuator cylinder and is filled with hydraulic fluid; V4 is located between; the inside of the first hollow piston rod, the outside of the second piston rod, the bottom of the second piston and the first piston as well as the end and inside diameter of the actuator cylinder and is filled with a low pressure gas (including vacuum); is located between; the outside of the first hollow piston rod, the top of the first piston as well as the end and inside diameter of the actuator cylinder and is filled with a hydraulic fluid;
further comprising conduit means between V3 and V5 adapted with a hydraulic pump adapted to transport oil under pressure between the respective volumes in any direction, adapted with control valves and a gas accumulator suitable for handling pump leakage and providing low flow restriction when the compensator is used in passive mode;
further comprising a number of tanks (T1, T2, . . . , TN) suitable for gas storage;
further comprising conduit means between V7 and the tank volumes (T1, T2, . . . , TN) adapted with control valves (CVA1, CVA2, . . . , CVAN) for adjustment of the volume size connected to V7;
further comprising conduit means between all gas volumes (V7, T1, T2, . . . , TN), the gas booster as well as the surroundings, adapted with control valves (CV4, CV5, CV6 CVB1, CVB2, . . . , CVBN), suited for pressure adjustment, both up and down, in all volumes as well as filling from the surroundings or release of pressure to the surroundings.

14. A transportable inline heave compensator according to claim 13, further comprising
a first MRU placed in a crane tip; and/or
a second MRU placed in the vicinity of the payload, adapted for transmitting wireless signals to the compensator, to improve control over the active actuator cylinder.

15. A transportable inline heave compensator according to claim 10, wherein mounting direction of actuator sheaves may be horizontal or vertical.

16. A transportable inline heave compensator according to claim 15, where the gas accumulator is a double acting gas accumulator.

17. A transportable inline heave compensator according to claim 16,
wherein the actuator sheaves are adapted for applying force to rope means, where the rope means is connected to a payload via connection device, such as a padeye, and minimum one secondary sheave, where the actuator sheave and the number of rope means is minimum one with no upper limit;
where the framework may be used as anchoring points for connection device, like padeyes, to connect the compensator to a crane, or similar machine;
further comprising a first actuator volume (V+), located between the actuator piston and piston side of the actuator cylinder, filled with oil for compression based designs and filled with gas (at any pressure, including vacuum) on tension based designs, a second actuator volume (V−), located between the actuator piston and rod side of the actuator cylinder, filled with oil on tension based designs and filled with gas (at any pressure, including vacuum) on compression based designs;
further comprising a position measurement means, such as a laser position sensor, a linear position sensor or an ultrasonic position sensor, to register the position of the actuator piston;
where (the gas accumulator is a) double acting gas accumulator comprising of a first cylinder, a ring shaped piston mounted concentrically within the first cylinder and adapted for reciprocation with respect thereto, where the lower end of the ring shaped piston is on the same side as the lower end of the first cylinder when the ring shaped piston is at zero stroke, a first inner cylinder mounted concentrically with and fixed to the upper end of the ring shaped piston, a second inner cylinder mounted concentrically within the first cylinder and fixed to the lower end of the first cylinder with a leak tight connection against the lower end of the first cylinder as well as a leak tight seal against the ring shaped piston, an inner piston mounted concentrically within the second inner cylinder with a leak tight seal against the first inner cylinder where the lower end of the inner piston is at the same level as the lower end of the ring piston, a third inner cylinder mounted concentrically within the first cylinder and fixed to the upper end of the inner piston and to a cylinder connector that joins the third inner cylinder with the first inner cylinder in a stiff connection, a stuffing box is mounted on top of the second inner cylinder to form a leak tight connection with the first inner cylinder, the cylinder connector has openings that allow free flow of fluids to either side of the cylinder connector, the second inner tube is equipped with means for transporting fluid, such as gun drilling the tube walls, from outside the double acting gas accumulator to the volume between the first inner tube and the second inner tube;
further comprising a first volume, located between the lower end of the ring piston, the lower end of the first cylinder and the outside of the first inner cylinder;
further comprising a second volume, located between the lower end of the inner piston, the lower end of the first cylinder and the inside of the second inner cylinder;
further comprising a third volume, located between the upper end of the ring piston, the outside of the first second cylinder, the inside of the first inner cylinder and the lower end of the stuffing box;
further comprising a fourth volume (V11), contains the remaining volume of the double acting accumulator not occupied by any parts or any other volumes;
further comprising a number of tanks (T1, T2, . . . , TN) suitable for gas storage;
further comprising conduit means between the first actuator volume (V+) and the first volume (V1) for compression based designs and conduit means between the second actuator volume (V−) and the first volume (V8) for tension based designs further comprising a sensing means adapted for measuring the vertical motion of the compensator;
further comprising one or more sensing means adapted for measuring the pressure in one or more volume;
further comprising a computer adapted for controlling the pump and the control valves based on input from the sensing means;
further comprising a communication means, such as acoustic communication while subsea and wirelessly while in air, adapted to transfer winch spooling data and other signals between the vessel and the compensator;
further comprising either a battery pack or an umbilical for energy supply.

18. A transportable inline heave compensator according to claim 17, further comprising
a gas booster, which can be of either single acting or double acting type, with or without area difference between gas and drive side, including means to drive it, which could be either hydraulic or gas based;
further comprising conduit means between the first actuator volume (V+), for tension based designs, and between the second actuator volume (V−), for compression based designs, and any number of tank volumes (T1, T2, . . . , TN), adapted with control valves (CVC1, CVC2, . . . , CVCN) for adjustment of the volume size connected to the actuator;
further comprising conduit means between all gas volumes (V11, V+ for tension based designs, V− for compression based designs, T1, T2, . . . , TN), the gas booster (160) as well as the surroundings, adapted with control valves (CV4, CV5, CV6, CVB0, CVB1, CVB2, . . . , CVBN), suited for pressure adjustment, both up and down, in all volumes as well as filling from the surroundings or release of pressure to the surroundings.

19. A transportable inline heave compensator according to claim 18, further comprising
a first MRU placed in a crane tip; and/or
a second MRU placed in the vicinity of the payload.

20. A transportable inline heave compensator according to claim 18, further comprising:
tailrods mounted to the actuator pistons, exposed to external pressure, with same diameter as the actuator rods.

21. A transportable inline heave compensator according to claim 8, wherein the incorporated curved device/device with a curved surface is minimum one drum (16) interacting with a pinion and a rack;
where the rack is integrated in the piston rod and interacting with the pinion, converting the rotational motion of the drum and pinion to linear motion of the rack and the actuator piston;
comprising bearing means, fixed to framework, for the drum allowing rotation of the drum.

22. A transportable inline heave compensator according to claim 21,
comprising a connection device in the other end, adapted for securing the rope means to at least one of: a vessel at the sea surface and a payload;
further comprising minimum one second connection device attached to either of; a rope means or a fixed point on the compensator, adapted for securing the rope means or the compensator to at least one of: a vessel at the sea surface and a payload.

23. A transportable inline heave compensator according to claim 22, wherein the compensator further comprises minimum a second tank for high pressure gas;
further comprising a means for gas transportation consisting of a pressure intensifier, connected to a pump, connected to a motor, connected to an energy source, to transport gas between the first accumulator, the first tank, the second tank and the surroundings;
further comprising a drum angle sensor(s), which may be located in one or both the actuators, the first accumulator or on the drum.

24. A transportable inline heave compensator according to claim 22,
where compensator further comprises minimum one second actuator, consisting of a cylinder and a piston, where the piston is connected to the rack, and adapted for reciprocation with respect thereto.

25. A transportable inline heave compensator according to claim 22, further comprises conduit means connecting the second actuator to the first actuator.

26. A transportable inline heave compensator according to claim 22, where compensator further comprises minimum one accelerometer.

27. A transportable inline heave compensator according to claim 22, where compensator further comprises minimum one pressure sensor for seawater pressure.

28. A transportable inline heave compensator according to claim 22, further comprising a second accumulator, consisting of a cylinder and piston, connected to the means for gas transportation via conduit means.

29. A transportable inline heave compensator according to claim 22, further comprises valve means (CV6, CV5, CVB2, CV7) to control gas flow in and out of the means for gas transportation.

30. A transportable inline heave compensator according to claim 22, further comprising:
communication means.

31. A transportable inline heave compensator according to claim 22, further comprising:
minimum one pressure intensifier connected to the second actuator via conduit means and to the second accumulator via conduit means, consisting of two cylinders, a piston and a rod,
minimum one hydraulic transportation means, connected to the pressure intensifier and the second accumulator via conduit means.

32. A transportable inline heave compensator according to claim 22, wherein the drum has a variable diameter with angle.
